(19) United States
(12) Patent Application Publication
(10) Pub. No.: US 2015/0053608 A1
(43) Pub. Date: Feb. 26, 2015

(54) POLYARYLNITRILE COPOLYMER MEMBRANES

(71) Applicant: General Electric Company, Schenectady, NY (US)

(72) Inventors: Gary William Yeager, Rexford, NY (US); Julia Lam Lee, Niskayuna, NY (US); Paul Edward Howson, Latham, NY (US); Hongyi Zhou, Niskayuna, NY (US); Cathryn Ellen Olsen, Wilton, NY (US); Patrick Joseph McCloskey, Watervliet, NY (US); Matthew Jeremiah Misner, Delanson, NY (US); Louisa Ruth Carr, Schenectady, NY (US); Daniel Steiger, Basking Ridge, NJ (US)

(73) Assignee: General Electric Company, Schenectady, NY (US)

(21) Appl. No.: 13/970,965

(22) Filed: Aug. 20, 2013

(51) Int. Cl. B01D 71/68; B01D 69/08; B01D 69/02; C08G 75/23

(52) U.S. Cl. CPC B01D 71/68; C08G 75/23; B01D 69/08; B01D 69/02; B01D 2325/36; B01D 2325/02
USPC 210/500.23; 528/173; 210/500.33

(57) ABSTRACT

A membrane including a polyarylnitrile copolymer is presented. The polyarylnitrile copolymer includes structural units having a formula (I) and at least one terminal group having a formula (II):

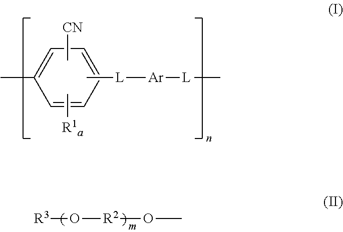

wherein “a” is 0, 1, 2, or 3; “m” is an integer having a value of 35 to 150; R¹ is independently at each occurrence a hyrogen atom, a halogen atom, a nitro group, a cyano group, a C₁-C₁₂ aliphatic radical, a C₃-C₁₂ cycloaliphatic radical, or a C₃-C₁₂ aromatic radical; R² and R³ are independently a C₁-C₁₂ aliphatic radical, a C₃-C₁₂ cycloaliphatic radical, or a C₃-C₁₂ aromatic radical; L is an oxygen atom or a sulfur atom; and Ar is independently at each occurrence a residue of an aromatic diol or a residue of an aromatic dihalide.

### BACKGROUND

The invention generally relates to polyarylnitrile copolymer membranes. More particularly, the invention relates to polyarylnitrile copolymer membranes for hemodialysis or hemofiltration.

Porous polymeric membranes, either in hollow fiber or flat sheet configurations may be employed in many applications, such as, hemodialysis, ultrafiltration, nanofiltration, reverse osmosis, gas separation, microfiltration, and pervaporation. For many of these applications, membranes with optimal selectivity as well as chemical, thermal and mechanical stability are desirable. In many applications (for example, hemodialysis or hemofiltration) it may also be desirable to have membranes with improved hydrophilicity and/or biocompatibility.

Polyarylene ethers, in particular, polyethersulfones and polysulfones are often used as membrane materials because of their mechanical, thermal, and chemical stability. However, these polymers may not have the optimal biocompatibility and hydrophilicity for many applications. Further improvements in membrane hydrophilicity have been achieved by polymer blending, for example, fabricating the porous membrane in the presence of small amounts of hydrophilic polymers such as polyvinylpyrollidone (PVP). However, since PVP is water-soluble it is slowly leached from the porous polymer matrix creating product variability. Alternatively, hydrophilicity has been achieved via functionalization of the polymer backbone and introduction of carboxyl, nitrile or polyethylene glycol functionality, which may also provide chemical resistance and good mechanical properties. However, these chemical modifications may be complicated, expensive and inefficient.

Thus porous membranes possessing optimal hydrophilicity and biocompatibility for hemodialysis and hemofiltration applications are desired. Further, polymers capable of being fabricated into porous membranes that possess sufficient hydrophilicity to obviate the need for blending with hydrophilic polymers are also desired.

### BRIEF DESCRIPTION OF THE INVENTION

Embodiments of the present invention are included to meet these and other needs. One embodiment is a membrane including a polyarylnitrile copolymer. The polyarylnitrile copolymer includes structural units having a formula (I) and at least one terminal group having a formula (II):

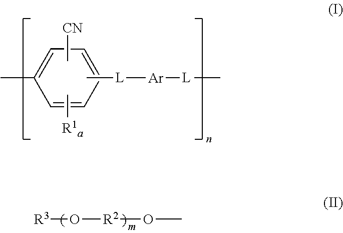

wherein “a” is 0, 1, 2, or 3; “m” is an integer having a value of 35 to 150; R¹ is independently at each occurrence a hyrogen atom, a halogen atom, a nitro group, a cyano group, a C₁-C₁₂ aliphatic radical, a C₃-C₁₂ cycloaliphatic radical, or a C₃-C₁₂ aromatic radical; R² and R³ are independently a C₁-C₁₂ aliphatic radical, a C₃-C₁₂ cycloaliphatic radical, or a C₃-C₁₂ aromatic radical; L is an oxygen atom or a sulfur atom; and Ar is independently at each occurrence a residue of an aromatic diol or a residue of an aromatic dihalide.

One embodiment is a membrane for hemodialysis or hemofiltration. The membrane includes a polyarylnitrile copolymer. The polyarylnitrile copolymer includes structural units having a formula (I) and at least one terminal group having a formula (II):

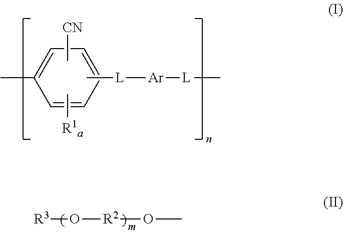

wherein “a” is 0, 1, 2, or 3; “m” is an integer having a value of 35 to 150; R¹ is independently at each occurrence a hyrogen atom, a halogen atom, a nitro group, a cyano group, a C₁-C₁₂ aliphatic radical, a C₃-C₁₂ cycloaliphatic radical, or a C₃-C₁₂ aromatic radical; R² and R³ are independently a C₁-C₁₂ aliphatic radical, a C₃-C₁₂ cycloaliphatic radical, or a C₃-C₁₂ aromatic radical; L is an oxygen atom or a sulfur atom; and Ar is independently at each occurrence a residue of an aromatic diol or a residue of an aromatic dihalide.

One embodiment is a polyarylnitrile copolymer including structural units having a formula (I) and at least one terminal group having a formula (II):

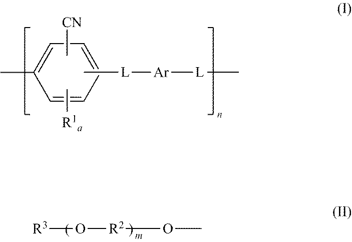

wherein “a” is 0, 1, 2, or 3; “m” is an integer having a value of 35 to 150; R¹ is independently at each occurrence a hyrogen atom, a halogen atom, a nitro group, a cyano group, a C₁-C₁₂ aliphatic radical, a C₃-C₁₂ cycloaliphatic radical, or a C₃-C₁₂ aromatic radical; R² and R³ are independently a C₁-C₁₂ aliphatic radical, a C₃-C₁₂ cycloaliphatic radical, or a C₃-C₁₂ aromatic radical; L is an oxygen atom or a sulfur atom; and Ar includes structural units having a formula (III), (IV), or combinations thereof

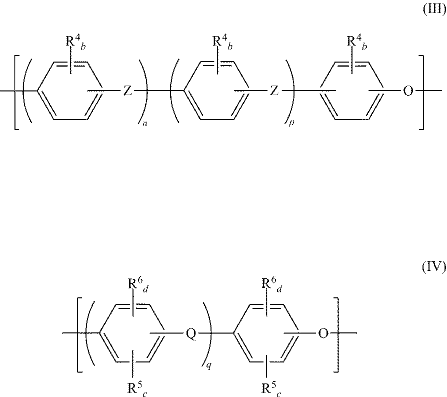

wherein “b” is 0, 1, 2, or 3; “c’ and ‘d” are independently 0, 1, 2, 3, or 4; “n”, “p” and “q” are independently 0 or 1; Z is a bond, an oxygen atom, a sulfur atom, a sulfinyl group, a sulfonyl group, a phenylphosphine group, a C₁-C₁₂ aliphatic radical, a C₃-C₁₂ cycloaliphatic radical, or a C₃-C₁₂ aromatic radical; Q is a bond, an oxygen atom, a sulfur atom, a C₁-C₁₂ aliphatic radical, a C₃-C₁₂ cycloaliphatic radical, or a C₃-C₁₂ aromatic radical; and R⁴, R⁵, and R⁶ are independently at each occurrence a hyrogen atom, a halogen atom, a nitro group, a C₁-C₁₂ aliphatic radical, a C₃-C₁₂ cycloaliphatic radical, or a C₃-C₁₂ aromatic radical.

### DRAWINGS

These and other features, aspects, and advantages of the present invention will become better understood when the following detailed description is read with reference to the accompanying drawings, wherein:

FIG. 1 shows the scanning electron micrographs of membranes cast using different coagulants, in accordance with some embodiments of the invention; and

FIG. 2 shows the normalized protein adhesion values for comparative samples and for hollow fiber membranes in accordance with some embodiments of the invention.

### DETAILED DESCRIPTION

As discussed in detail below, some of the embodiments of the invention include polyarylnitrile copolymer membranes. More particularly, the invention relates to polyarylnitrile copolymer membranes for hemodialysis or hemofiltration.

Approximating language, as used herein throughout the specification and claims, may be applied to modify any quantitative representation that could permissibly vary without resulting in a change in the basic function to which it is related. Accordingly, a value modified by a term or terms, such as “about”, and “substantially” is not to be limited to the precise value specified. In some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

In the following specification and the claims, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthraceneyl groups (n=3) and the like. The aromatic radical may also include nonaromatic components. For example, a benzyl group is an aromatic radical, which comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂)₄—. For convenience, the term “aromatic radical” is defined herein to encompass a wide range of functional groups such as alkyl groups, alkenyl groups, alkynyl groups, haloalkyl groups, haloaromatic groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylphenyl radical is a C₇ aromatic radical comprising a methyl group, the methyl group being a functional group which is an alkyl group. Similarly, the 2-nitrophenyl group is a C₆ aromatic radical comprising a nitro group, the nitro group being a functional group. Aromatic radicals include halogenated aromatic radicals such as 4-trifluoromethylphenyl, hexafluoroisopropylidenebis(4-phen-1-yloxy) (i.e., —OPhC(CF₃)₂PhO—), 4-chloromethylphen-1-yl, 3-trifluorovinyl-2-thienyl, 3-trichloromethylphen-1-yl (i.e., 3-CCl₃Ph-), 4-(3-bromoprop-1-yl)phen-1-yl (i.e., 4-BrCH₂CH₂CH₂Ph-), and the like. Further examples of aromatic radicals include 4-allyloxyphen-1-oxy, 4-aminophen-1-yl (i.e., 4-H₂NPh-), 3-aminocarbonylphen-1-yl (i.e., NH₂COPh-), 4-benzoylphen-1-yl, dicyanomethylidenebis(4-phen-1-yloxy) (i.e., —OPhC(CN)₂PhO—), 3-methylphen-1-yl, methylenebis(4-phen-1-yloxy) (i.e., —OPhCH₂PhO—), 2-ethylphen-1-yl, phenylethenyl, 3-formyl-2-thienyl, 2-hexyl-5-furanyl, hexamethylene-1,6-bis(4-phen-1-yloxy) (i.e., —OPh(CH₂)₆PhO—), 4-hydroxymethylphen-1-yl (i.e., 4-HOCH₂Ph-), 4-mercaptomethylphen-1-yl (i.e., 4-HSCH₂Ph-), 4-methylthiophen-1-yl (i.e., 4-CH₃SPh-), 3-methoxyphen-1-yl, 2-methoxycarbonylphen-1-yloxy (e.g., methyl salicyl), 2-nitromethylphen-1-yl (i.e., 2-NO₂CH₂Ph), 3-trimethylsilylphen-1-yl, 4-t-butyldimethylsilylphenl-1-yl, 4-vinylphen-1-yl, vinylidenebis(phenyl), and the like. The term “a C₃-C₁₀ aromatic radical” includes aromatic radicals containing at least three but no more than 10 carbon atoms. The aromatic radical 1-imidazolyl (C₃H₂N₂—) represents a C₃ aromatic radical. The benzyl radical (C₇H₇—) represents a C₇ aromatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more noncyclic components. For example, a cyclohexylmethyl group (C₆H₁₁CH₂—) is a cycloaliphatic radical which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. For convenience, the term “cycloaliphatic radical” is defined herein to encompass a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylcyclopent-1-yl radical is a C₆ cycloaliphatic radical comprising a methyl group, the methyl group being a functional group which is an alkyl group. Similarly, the 2-nitrocyclobut-1-yl radical is a C₄ cycloaliphatic radical comprising a nitro group, the nitro group being a functional group. A cycloaliphatic radical may comprise one or more halogen atoms, which may be the same or different. Halogen atoms include, for example; fluorine, chlorine, bromine, and iodine. Cycloaliphatic radicals comprising one or more halogen atoms include 2-trifluoromethylcyclohex-1-yl, 4-bromodifluoromethylcyclooct-1-yl, 2-chlorodifluoromethylcyclohex-1-yl, hexafluoroisopropylidene-2,2-bis(cyclohex-4-yl) (i.e., —C₆H₁₀C(CF₃)₂C₆H₁₀—), 2-chloromethylcyclohex-1-yl, 3-difluoro methylenecyclohex-1-yl, 4-trichloromethylcyclohex-1-yloxy, 4-bromodichloro methylcyclohex-1-ylthio, 2-bromoethylcyclopent-1-yl, 2-bromopropylcyclohex-1-yloxy (e.g., CH₃CHBrCH₂C₆H₁₀O—), and the like. Further examples of cycloaliphatic radicals include 4-allyloxycyclohex-1-yl, 4-aminocyclohex-1-yl (i.e., H₂NC₆H₁₀—), 4-aminocarbonylcyclopent-1-yl (i.e., NH₂COC₅H₈—), 4-acetyloxycyclohex-1-yl, 2,2-dicyanoisopropylidenebis(cyclohex-4-yloxy) (i.e., —OC₆H₁₀C(CN)₂C₆H₁₀O—), 3-methylcyclohex-1-yl, methylenebis(cyclohex-4-yloxy) (i.e., OC₆H₁₀CH₂C₆H₁₀O—), 1-ethylcyclobut-1-yl, cyclopropylethenyl, 3-formyl-2-terahydrofuranyl, 2-hexyl-5-tetrahydrofuranyl, hexamethylene-1,6-bis(cyclohex-4-yloxy) (i.e., OC₆H₁₀(CH₂)₆C₆H₁₀O—), 4-hydroxymethylcyclohex-1-yl (i.e., 4-HOCH₂C₆H₁₀—), 4-mercaptomethylcyclohex-1-yl (i.e., 4-HSCH₂C₆H₁₀—), 4-methylthiocyclohex-1-yl (i.e., 4-CH₃SC₆H₁₀—), 4-methoxycyclohex-1-yl, 2-methoxycarbonylcyclohex-1-yloxy(2-CH₃OCOC₆H₁₀O—), 4-nitromethylcyclohex-1-yl (i.e., NO₂CH₂C₆H₁₀—), 3-trimethylsilylcyclohex-1-yl, 2-t-butyldimethylsilylcyclopent-1-yl, 4-trimethoxysilylethylcyclohex-1-yl (e.g., (CH₃O)₃SiCH₂CH₂C₆H₁₀—), 4-vinylcyclohexen-1-yl, vinylidenebis(cyclohexyl), and the like. The term “a C₃-C₁₀ cycloaliphatic radical” includes cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

As used herein the term “aliphatic radical” refers to an organic radical having a valence of at least one consisting of a linear or branched array of atoms which is not cyclic. Aliphatic radicals are defined to comprise at least one carbon atom. The array of atoms comprising the aliphatic radical may include heteroatoms such as nitrogen, sulfur, silicon, selenium and oxygen or may be composed exclusively of carbon and hydrogen. For convenience, the term “aliphatic radical” is defined herein to encompass, as part of the “linear or branched array of atoms which is not cyclic” a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylpent-1-yl radical is a C₆ aliphatic radical comprising a methyl group, the methyl group being a functional group which is an alkyl group. Similarly, the 4-nitrobut-1-yl group is a C₄ aliphatic radical comprising a nitro group, the nitro group being a functional group. An aliphatic radical may be a haloalkyl group which comprises one or more halogen atoms which may be the same or different. Halogen atoms include, for example; fluorine, chlorine, bromine, and iodine. Aliphatic radicals comprising one or more halogen atoms include the alkyl halides trifluoromethyl, bromodifluoromethyl, chlorodifluoromethyl, hexafluoroisopropylidene, chloromethyl, difluorovinylidene, trichloromethyl, bromodichloromethyl, bromoethyl, 2-bromotrimethylene (e.g., —CH₂CHBrCH₂—), and the like. Further examples of aliphatic radicals include allyl, aminocarbonyl (i.e., CONH₂), carbonyl, 2,2-dicyanoisopropylidene (i.e., —CH₂C(CN)₂CH₂—), methyl (i.e., —CH₃), methylene (i.e., —CH₂—), ethyl, ethylene, formyl (i.e., —CHO), hexyl, hexamethylene, hydroxymethyl (i.e., —CH₂OH), mercaptomethyl (i.e., —CH₂SH), methylthio (i.e., —SCH₃), methylthiomethyl (i.e., —CH₂SCH₃), methoxy, methoxycarbonyl (i.e., —CH₃OCO—), nitro methyl (i.e., —CH₂NO₂), thiocarbonyl, trimethylsilyl (i.e., (CH₃)₃Si—), t-butyldimethylsilyl, 3-trimethyoxysilylpropyl (i.e., (CH₃O)₃SiCH₂CH₂CH₂—), vinyl, vinylidene, and the like. By way of further example, a C₁-C₁₀ aliphatic radical contains at least one but no more than 10 carbon atoms. A methyl group (i.e., CH₃—) is an example of a C₁ aliphatic radical. A decyl group (i.e., CH₃(CH₂)₉—) is an example of a C₁₀ aliphatic radical.

As discussed in detail below, some embodiments of the invention are directed to a membrane composed of a polyarylnitrile copolymer. The polyarylnitrile copolymer may be a block copolymer or a random copolymer. A block copolymer contains blocks of monomers of the same type that may be arranged sequentially, while a random copolymer contains a random arrangement of the multiple monomers making up the copolymer.

The polyarylnitrile copolymer includes structural units having a formula (I), and at least one terminal group having a formula (II):

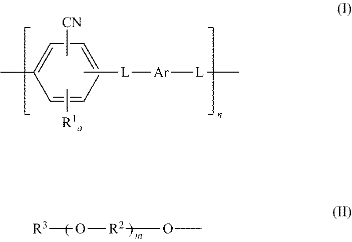

wherein “a” is 0, 1, 2, or 3;
“m” is an integer having a value of 35 to 150;
R¹ is independently at each occurrence a hyrogen atom, a halogen atom, a nitro group, a cyano group, a C₁-C₁₂ aliphatic radical, a C₃-C₁₂ cycloaliphatic radical, or a C₃-C₁₂ aromatic radical;
R² and R³ are independently a C₁-C₁₂ aliphatic radical, a C₃-C₁₂ cycloaliphatic radical, or a C₃-C₁₂ aromatic radical;
L is an oxygen atom or a sulfur atom; and
Ar is independently at each occurrence a residue of an aromatic diol or a residue of an aromatic dihalide.

In some embodiments, Ar includes structural units having a formula (III), (IV), or combinations thereof

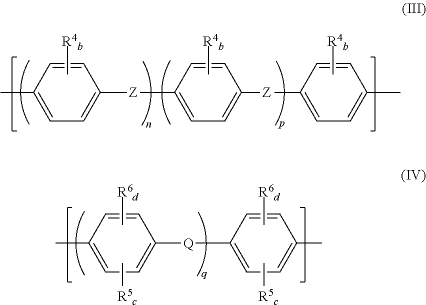

wherein “b”, “c’ and ‘d” are independently 0, 1, 2, 3, or 4;
“n”, “p” and “q” are independently 0 or 1;
Z is a bond, an oxygen atom, a sulfur atom, a sulfinyl group, a sulfonyl group, a phenylphosphine group, a C₁-C₁₂ aliphatic radical, a C₃-C₁₂ cycloaliphatic radical, or a C₃-C₁₂ aromatic radical;
Q is a bond, an oxygen atom, a sulfur atom, a C₁-C₁₂ aliphatic radical, a C₃-C₁₂ cycloaliphatic radical, or a C₃-C₁₂ aromatic radical; and
R⁴, R⁵, and R⁶ are independently at each occurrence a hyrogen atom, a halogen atom, a nitro group, a C₁-C₁₂ aliphatic radical, a C₃-C₁₂ cycloaliphatic radical, or a C₃-C₁₂ aromatic radical.

In particular embodiments, the polyarylnitrile copolymer includes structural units having a formula (V)

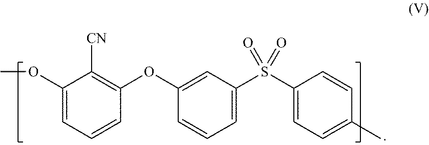

As noted earlier, the polyarylnitrile copolymer further includes at least one terminal group having a formula (II). In some embodiments, both the terminal groups of the polyarylnitrile copolymer have a formula (II). In some embodiments, the terminal group having a formula (II) includes at least one polyethylene glycol moiety. In particular embodiments, the terminal group includes polyethylene glycol monomethyl ether.

In some embodiments, the membrane is composed of a polyarylnitrile copolymer having a formula (VI):

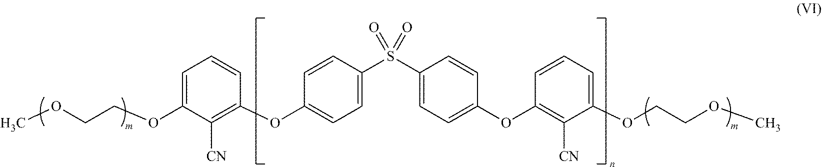

Without being bound by any theory, it is believed that the terminal group of the polyarylnitrile copolymer may provide for improved hydrophilicity and biocompatibility of the polyarylnitrile copolymer, without affecting the membrane-formation.

In some embodiments, “m’ in formula (I) has a value from 40 to 120. In some embodiments, an amount of the terminal group in the polyarylnitrile copolymer is in a range from about 2 weight percent to about 25 weight percent. In some embodiments, an amount of the terminal group in the polyarylnitrile copolymer is in a range from about 2 weight percent to about 10 weight percent.

In some embodiments, a molecular weight of the terminal group in the polyarylnitrile copolymer is in a range from about 2000 grams/mole to about 10000 grams/mole. In some embodiments, a molecular weight of the terminal group in the polyarylnitrile copolymer is in a range from about 2000 grams/mole to about 5000 grams/mole.

A polyarylnitrile copolymer is also presented. The polyarylnitrile copolymer includes structural units having a formula (I) and at least one terminal group having a formula (II)

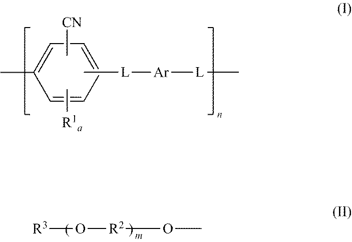

wherein “a” is 0, 1, 2, or 3;
“m” is an integer having a value of 35 to 150;
R¹ is independently at each occurrence a hyrogen atom, a halogen atom, a nitro group, a cyano group, a C₁-C₁₂ aliphatic radical, a C₃-C₁₂ cycloaliphatic radical, or a C₃-C₁₂ aromatic radical;
R² and R³ are independently a C₁-C₁₂ aliphatic radical, a C₃-C₁₂ cycloaliphatic radical, or a C₃-C₁₂ aromatic radical;
L is an oxygen atom or a sulfur atom; and
Ar comprises structural units having a formula (III), (IV), or combinations thereof

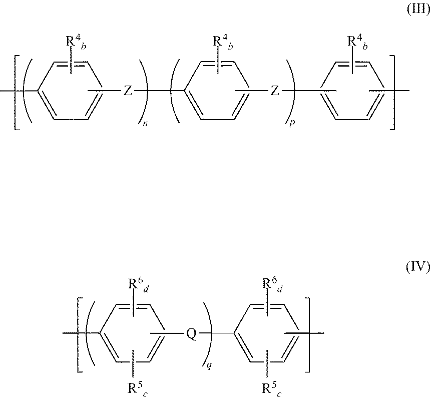

The polyarylnitrile copolymers may be produced by reacting at least one dihalobenzonitrile with at least one aromatic dihydroxy compound or by reacting at least one dihydroxybenzonitrile with at least one aromatic dihalide compound. The reaction may be effected in a polar aprotic solvent in the presence of an alkali metal compound, and optionally, in the presence of catalysts. Other dihalo aromatic compounds in addition to the dihalobenzonitrile may also be used to form block or random copolymers.

Some examples of the dihalobenzonitrile monomers useful for preparing the polyarylnitrile copolymers of the present invention include 2,6-dichlorobenzonitrile, 2,6-difluorobenzonitrile, 2,5-dichlorobenzonitrile, 2,5-difluorobenzonitrile, 2,4-dichlorobenzonitrile, and 2,4-difluorobenzonitrile.

Exemplary dihalo aromatic compounds that may be used include 4,4′-bis(chlorophenyl)sulfone, 2,4′-bis(chlorophenyl)sulfone, 2,4-bis(chlorophenyl)sulfone, 4,4′-bis(fluorophenyl)sulfone, 2,4′-bis(fluorophenyl)sulfone, 2,4-bis(fluorophenyl)sulfone, 4,4′-bis(chlorophenyl)sulfoxide, 2,4′-bis(chlorophenyl)sulfoxide, 2,4-bis(chlorophenyl)sulfoxide, 4,4′-bis(fluorophenyl)sulfoxide, 2,4′-bis(fluorophenyl)sulfoxide, 2,4-bis(fluorophenyl)sulfoxide, 4,4′-bis(fluorophenyl)ketone, 2,4′-bis(fluorophenyl)ketone, 2,4-bis(fluorophenyl)ketone, 1,3-bis(4-fluorobenzo yl)benzene, 1,4-bis(4-fluorobenzoyl)benzene, 4,4′-bis(4-chlorophenyl)phenylphosphine oxide, 4,4′-bis(4-fluorophenyl)phenylphosphine oxide, 4,4′-bis(4-fluorophenylsulfonyl)-1,1′-biphenyl, 4,4′-bis(4-chlorophenylsulfonyl)-1,1′-biphenyl, 4,4′-bis(4-fluorophenylsulfoxide)-1,1′-biphenyl, and 4,4′-bis(4-chlorophenylsulfoxide)-1,1′-biphenyl.

Non-limiting examples of suitable aromatic dihydroxy compounds that may be used include 4,4′-dihydroxyphenyl sulfone, 2,4′-dihydroxyphenyl sulfone, 4,4′-dihydroxyphenyl sulfoxide, 2,4′-dihydroxyphenyl sulfoxide, bis(3,5-dimethyl-4-hydroxyphenyl)sulfoxide, bis(3,5-dimethyl-4-hydroxyphenyl)sulfone, 4,4-(phenylphosphinyl)diphenol, 4,4′-oxydiphenol, 4,4′-thiodiphenol, 4,4′-dihydroxybenzophenone, 4,4′dihydroxyphenylmethane, hydroquinone, resorcinol, 5-cyano-1,3-dihydroxybenzene, 4-cyano-1,3,-dihydroxybenzene, 2-cyano-1,4-dihydroxybenzene, 2-methoxyhydroquinone, 2,2′-biphenol, 4,4′-biphenol, 2,2′-dimethylbiphenol 2,2′,6,6′-tetramethylbiphenol, 2,2′,3,3′,6,6′-hexamethylbiphenol, 3,3′,5,5′-tetrabromo-2,2′6,6′-tetramethylbiphenol, 4,4′-isopropylidenediphenol (bisphenol A), 4,4′-isopropylidenebis(2,6-dimethylphenol) (teramethylbisphenol A), 4,4′-isopropylidenebis(2-methylphenol), 4,4′-isopropylidenebis(2-allylphenol), 4,4′-isopropylidenebis(2-allyl-6-methylphenol), 4,4′(1,3-phenylenediisopropylidene)bisphenol (bisphenol M), 4,4′-isopropylidenebis(3-phenylphenol), 4,4′-isopropylidene-bis(2-phenylphenol), 4,4′-(1,4-phenylenediisoproylidene)bisphenol (bisphenol P), 4,4′-ethylidenediphenol (bisphenol E), 4,4′-oxydiphenol, 4,4′-thiodiphenol, 4,4′-thiobis(2,6-dimethylphenol), 4,4′-sufonyldiphenol, 4,4′-sufonylbis(2,6-dimethylphenol) 4,4′-sulfinyldiphenol, 4,4′-hexafluoroisoproylidene)bisphenol (Bisphenol AF), 4,4′-hexafluoroisoproylidene)bis(2,6-dimethylphenol), 4,4′-(1-phenylethylidene)bisphenol (Bisphenol AP), 4,4′-(1-phenylethylidene)bis(2,6-dimethylphenol), bis(4-hydroxyphenyl)-2,2-dichloroethylene (Bisphenol C), bis(4-hydroxyphenyl)methane (Bisphenol-F), bis(2,6-dimethyl-4-hydroxyphenyl)methane, 2,2-bis(4-hydroxyphenyl)butane, 3,3-bis(4-hydroxyphenyl)pentane, 4,4′-(cyclopentylidene)diphenol, 4,4′-(cyclohexylidene)diphenol (Bisphenol Z), 4,4′-(cyclohexylidene)bis(2-methylphenol), 4,4′-(cyclododecylidene)diphenol, 4,4′-(bicyclo[2.2.1]heptylidene)diphenol, 4,4′-(9H-fluorene-9,9-diyl)diphenol, 3,3′-bis(4-hydroxyphenyl)isobenzofuran-1 (3H)-one, 1-(4-hydroxyphenyl)-3,3′-dimethyl-2,3-dihydro-1H-inden-5-ol, 1-(4-hydroxy-3,5-dimethylphenyl)-1,3,3′,4,6-pentamethyl-2,3-dihydro-1H-in-den-5-ol, 3,3,3′,3′-tetramethyl-2,2′,3,3′-tetrahydro-1,1′-spirobi[indene]-5,6′-diol (Spirobiindane), dihydroxybenzophenone (bisphenol K), thiodiphenol (Bisphenol S), bis(4-hydroxyphenyl)diphenyl methane, bis(4-hydroxyphenoxy)-4,4′-biphenyl, 4,4′-bis(4-hydroxyphenyl)diphenyl ether, 9,9-bis(3-methyl-4-hydroxyphenyl) fluorene, and N-phenyl-3,3-bis-(4-hydroxyphenyl)phthalimide.

The dihalobenzonitrile may be used in substantially equimolar amounts relative to the dihydroxy aromatic compound in the reaction mixture. The term “substantially equimolar amounts” means a molar ratio of the dihalobenzonitrile compound(s) to dihydroxy aromatic compound(s) is in a range from about 0.85 to about 1.2.

A basic salt of an alkali metal compound may be used to effect the reaction between the dihalo and dihydroxy aromatic compounds. Exemplary compounds include alkali metal hydroxides, such as, but not limited to, lithium hydroxide, sodium hydroxide, potassium hydroxide, rubidium hydroxide, and cesium hydroxide; alkali metal carbonates, such as, but not limited to, lithium carbonate, sodium carbonate, potassium carbonate, rubidium carbonate, and cesium carbonate; and alkali metal hydrogen carbonates, such as but not limited to lithium hydrogen carbonate, sodium hydrogen carbonate, potassium hydrogen carbonate, rubidium hydrogen carbonate, and cesium hydrogen carbonate. Combinations of these compounds may also be used to effect the reaction.

Some examples of the aprotic polar solvent that may be used include N,N-dimethylformamide, N,N-diethylformamide, N,N-dimethylacetamide, N,N-diethylacetamide, N,N-dipropylacetamide, N,N-dimethylbenzamide, N-methyl-2-pyrrolidone (NMP), N-ethyl-2-pyrrolidone, N-isopropyl-2-pyrrolidone, N-isobutyl-2-pyrrolidone, N-n-propyl-2-pyrrolidone, N-n-butyl-2-pyrrolidone, N-cyclohexyl-2-pyrrolidone, N-methyl-3-methyl-2-pyrrolidone, N-ethyl-3-methyl-pyrrolidone, N-methyl-3,4,5-trimethyl-2-pyrrolidone, N-methyl-2-piperidone, N-ethyl-2-piperidone, N-isopropyl-2-piperidone, N-methyl-6-methyl-2-piperidone, N-methyl-3-ethylpiperidone, dimethylsulfoxide (DMSO), diethylsulfoxide, sulfolane, 1-methyl-1-oxosulfolane, 1-ethyl-1-oxosulfolane, 1-phenyl-1-oxo sulfolane, N,N′-dimethylimidazolidinone (DMI), diphenylsulfone, and combinations thereof. The amount of solvent to be used is typically an amount that is sufficient to dissolve the dihalo and dihydroxy aromatic compounds.

The reaction may be conducted at a temperature in a range from about 100° C. to about 300° C. in some embodiments, from about 120° C. to about 200° C. in some embodiments, and from about 150° C. to about 200° C. in particular embodiments. The reaction mixture may be further dried by addition to the initial reaction mixture of, along with the polar aprotic solvent, a solvent that forms an azeotrope with water.

Examples of such solvents include toluene, benzene, xylene, ethylbenzene and chlorobenzene. After removal of residual water by azeotropic drying, the reaction may be carried out at the elevated temperatures described above. The reaction is typically conducted for a time period ranging from about 1 hour to about 72 hours in some embodiments, and from about 1 hour to about 10 hours in particular embodiments.

In embodiments wherein halogenated aromatic solvents are used, phase transfer catalysts may be employed. Suitable phase transfer catalysts include hexaalkylguanidinium salts and bis-guanidinium salts. Typically, the phase transfer catalyst includes an anionic species such as halide, mesylate, tosylate, tetrafluoroborate, or acetate as the charge-balancing counterion(s). Other suitable phase transfer catalysts include p-dialkylamino-pyridinium salts, bis-dialkylaminopyridinium salts, bis-quaternary ammonium salts, bis-quaternary phosphonium salts, and phosphazenium salts.

After completion of the reaction, the copolymer may be separated from the inorganic salts, precipitated into a non-solvent and collected by filtration and drying. Examples of non-solvents include water, methanol, ethanol, propanol, butanol, acetone, methyl ethyl ketone, methyl isobutyl ketone, gamma.-butyrolactone, and combinations thereof.

The glass transition temperature, T_{g}, of the polyarylnitrile copolymer may be in a range from about 120° C. to about 280° C. in one embodiment, and may be in a range from about 140° C. to about 200° C. in another embodiment. The polyarylnitrile copolymer may be further characterized by the number average molecular weight (Mₙ). In one embodiment, the Mₙ of the copolymer may be in the range from about 10,000 grams per mole (g/mol) to about 1,000,000 g/mol. In another embodiment, the Mₙ may be in a range from about 15,000 g/mol to about 200,000 g/mol.

The polyarylnitrile copolymer and the membrane including the polyarylnitrile copolymer may be further characterized by its hydrophilicity. In some embodiments, the polyarylnitrile copolymer has a contact angle with water less than about 80 degrees measured on a surface of the polyarylnitrile copolymer cast as a film on a glass substrate. In some embodiments, the polyarylnitrile copolymer has a contact angle with water less than about 50 degrees measured on a surface of the polyarylnitrile copolymer cast as a film on a glass substrate. In particular embodiments, the polyarylnitrile copolymer has a contact angle with water less than about 30 degrees measured on a surface of the polyarylnitrile copolymer cast as a film on a glass substrate.

The membrane may have a hollow fiber configuration or a flat sheet configuration. In particular embodiments, the membrane may have a hollow fiber configuration. In some embodiments, a hollow fiber membrane composed of a polyarylnitrile copolymer having structural units of a formula (I) and at least one terminal group of a formula (II) is presented. In some embodiments, a hollow-fiber membrane module including a plurality of hollow-fiber membranes is presented.

The membranes in accordance with embodiments of the invention may be made by processes known in the art. Suitable techniques include, but are not limited to: dry-phase separation membrane formation process; wet-phase separation membrane formation process; dry-wet phase separation membrane formation process; thermally-induced phase-separation membrane formation process. Further, post membrane-formation, the membrane may be subjected to a membrane conditioning process or a pretreatment process prior to its use in a separation application. Representative processes may include thermal annealing to relieve stresses or pre-equilibration in a solution similar to the feed stream the membrane will contact.

In one embodiment, the membranes may be prepared by phase inversion. The phase inversion process includes 1) vapor-induced phase separation (VIPS), also called “dry casting” or “air casting”; 2) liquid-induced phase separation (LIPS), mostly referred to as “immersion casting” or “wet casting”; and 3) thermally induced phase separation (TIPS), frequently called “melt casting”. The phase inversion process can produce integrally skinned asymmetric membranes. In some embodiments, the membranes may be cross-linked to provide additional support.

The membrane may be designed to have specific pore sizes so that solutes having sizes greater than the pore sizes may not be able to pass through. In one embodiment, the pore size may be in a range from about 0.5 nanometers to about 100 nanometers. In another embodiment, the pore size may be in a range from about 1 nanometer to about 25 nm.

In some embodiments, the hollow fiber membrane may include a blend of a polyarylnitrile copolymer described earlier with at least one additional polymer. The additional polymer may be blended with the polyarylnitrile copolymer to impart different properties such as better heat resistance, biocompatibility, and the like. Furthermore, the additional polymer may be added to the polyarylnitrile during the membrane formation to modify the morphology of the phase inverted membrane structure produced upon phase inversion, such as asymmetric membrane structures. In addition, at least one polymer that is blended with the polyarylnitrile may be hydrophilic or hydrophobic in nature.

In some embodiments, the polyarylnitrile is blended with a hydrophilic polymer. Non-limiting example of a suitable hydrophilic polymer includes polyvinylpyrrolidone (PVP). Non-limiting examples of other suitable hydrophilic polymers include polyoxazoline, polyethyleneglycol, polypropylene glycol, polyglycolmonoester, copolymer of polyethyleneglycol with polypropylene glycol, water-soluble cellulose derivative, polysorbate, polyethylene-polypropylene oxide copolymer, polyethyleneimine, and combinations thereof. In some embodiments, the polyarylnitrile copolymer may be further blended with polymers, such as, polysulfone, polyether sulfone, polyether urethane, polyamide, polyether-amide, polyacrylonitrile, and combinations thereof.

The membranes in accordance with some embodiments of the invention may have use in various applications, such as, hemofiltration, hemodialysis, ultrafiltration, nanofiltration, gas separation, microfiltration, reverse osmosis, and pervaporation. In particular embodiments, the membranes may have applications in the biomedical field where improved hydrophilicity and biocompatibility are desired.

In some embodiments, membrane for hemofiltration or hemodialysis is presented. The membrane is composed of a polyarylnitrile copolymer including structural units having a formula (I) and at least one terminal group having a formula (II). In another aspect, the present invention relates to a dialysis apparatus that includes a plurality of porous hollow fibers composed of the porous membranes of the present invention.

Dialysis refers to a process effected by one or more membranes in which transport is driven primarily by pressure differences across the thickness of the one or more membrane. Hemodialysis refers to a dialysis process in which biologically undesired and/or toxic solutes, such as metabolites and by-products are removed from blood. Hemodialysis membranes are porous membranes permitting the passage of low molecular weight solutes, typically less than 5,000 Daltons, such as urea, creatinine, uric acid, electrolytes and water, yet preventing the passage of higher molecular weight proteins and blood cellular elements. Hemofiltration, which more closely represents the filtration in the glomerulus of the kidney, requires even more permeable membranes allowing complete passage of solutes of molecular weight of less than 50,000 Daltons, and, in some cases, less than 20,000 Daltons

Without being bound by any theory it is believed that the polyarylnitrile copolymer in accordance some embodiments of the present invention has the desired mechanical properties so as to support the porous membrane structure during manufacture and use. In addition, the copolymer has adequate thermal properties so as not to degrade during high temperature steam sterilization processes. Further, the copolymer and the corresponding membranes have optimal biocompatibility, such that protein fouling is minimized and thrombosis of the treated blood does not occur.

### EXAMPLES

Chemicals were purchased from Aldrich and Sloss Industries and used as received, unless otherwise noted. NMR spectra were recorded on a Bruker Avance 400 (¹H, 400 MHz) spectrometer and referenced versus residual solvent shifts. Molecular weights are reported as number average (Mₙ) or weight average (M_{w}) molecular weight and were determined by gel permeation chromatography (GPC) analysis on a Perkin Elmer Series 200 instrument equipped with UV detector. Polymer thermal analysis was performed on a Perkin Elmer DSC7 equipped with a TACT/DX thermal analyzer and processed using Pyris Software.

Glass transition temperatures were recorded on the second heating scan. Contact angle measurements were taken on a VCA 2000 (Advanced Surface Technology, Inc.) instrument using VCAoptima Software for evaluation. Polymer films were obtained from casting a thin film from an appropriate solution, such as, dimethyl sulfoxide (DMSO), N-methyl-2-pyrrolidone (NMP), and dimethylacetamide (DMAC) onto a clean glass slide and evaporation of the solvent. Advancing contact angles with water (73 Dynes/cm) were determined on both sides of the film (facing air and facing glass slide). Consistently lower values were obtained on the side facing the glass slide presumably due to the smoother surface.

### Example 1

### Copolymer of Poly(Ethylene Glycol)Monomethyl Ether, 4,4-Sulfonylbiphenol and 2,6-Difluorobenzonitrile. (1 Mol % PEG/Dihalide)

A 100 ml round-bottomed flask affixed with a distillation head, nitrogen bypass and a mechanical stirrer was charged with 11.2053 g (44.7720 mmol) of 4,4-sulfonylbiphenol, 2.253 g (0.4506 mmol) poly(ethylene glycol)monomethylether, 6.2592 g (44.9964 mmol) of 2,6-difluorobenzonitrile, 9.3252 g (67.4733 mmol) of potassium bicarbonate, 41.4 g of dimethylacetamide, and 13 mL of toluene. The reaction temperature was increased to 150-160° C. and toluene was removed by distillation. After 5.25 hours, the reaction temperature was cooled to 80° C. and diluted with 100 mL of DMAC. The solution was filtered then precipitated into water. The product was filtered, washed with water and dried overnight in vacuo to yield 16.01 g (89%) of the desired product. GPC(NMP): M_{w}=87K, Mₙ=37K, PDI 2.33. DSC: T_{g}=155° C. (weak signal). Contact angle: Top Surface (facing air) 80±2.6; bottom surface (facing glass); 67±10.1.

### Example 2

### Copolymer of Poly(Ethylene Glycol)Monomethyl Ether, 4,4-Sulfonylbiphenol and 2,6-Difluorobenzonitrile. (4 Mol % PEG/Dihalide)

A 250 ml round-bottomed flask affixed with a distillation head, nitrogen bypass and a mechanical stirrer was charged with 11.2345 g (44.8886 mmol) of 4,4-sulfonylbiphenol, 9.3518 g (1.8704 mmol) poly(ethylene glycol)monomethylether, 6.5009 g (46.7339 mmol) of 2,6-difluorobenzonitrile, 9.7612 g (70.628 mmol) of potassium bicarbonate, 58 g of N,N-dimethylacetamide, and 20 ml of toluene. The reaction temperature was increased to 150-160° C. and toluene was removed by continuous distillation. After 395 minutes, the reaction was cooled to 80° C. and diluted with 100 ml of DMAC. The solution was filtered then precipitated into water. The product was filtered, washed with water and dried overnight in vacuo to yield 17.24 g (71%) of the desired product. GPC(NMP): Mw=30K, Mn=13K, PDI 2.21. DSC: Tg=124° C.

### Example 3

### Copolymer of Poly(Ethylene Glycol)Monomethyl Ether, 4,4-Sulfonylbiphenol and 2,6-Difluorobenzonitrile. (3 Mol % PEG/Dihalide)

A 100 ml round-bottomed flask affixed with a distillation head, nitrogen bypass and a mechanical stirrer was charged with 12.5925 g (50.315 mmol) of 4,4-sulfonylbiphenol, 7.6749 g (1.535 mmol) poly(ethylene glycol)monomethyl ether, 7.11 g (51.111 mmol) of 2,6-difluorobenzonitrile, 10.617 g (76.820 mmol) of potassium bicarbonate, 67 g of dimethylacetamide, and 30 ml of toluene. The reaction temperature was increased to 150-160° C. and toluene was removed by distillation. After 300 minutes, the reaction temperature was cooled to 80° C. and diluted with 111 ml of DMAC. The solution was filtered then precipitated into water. The product was filtered, washed with water and rinsed with methanol, dried overnight at 50-60° C. in vacuo to yield 17.68 g (70%) of the desired product. GPC(NMP): Mw=37K, Mn=15.2K, PDI 2.46. DSC: Tg=122° C.

### Example 4

### Membrane Formation

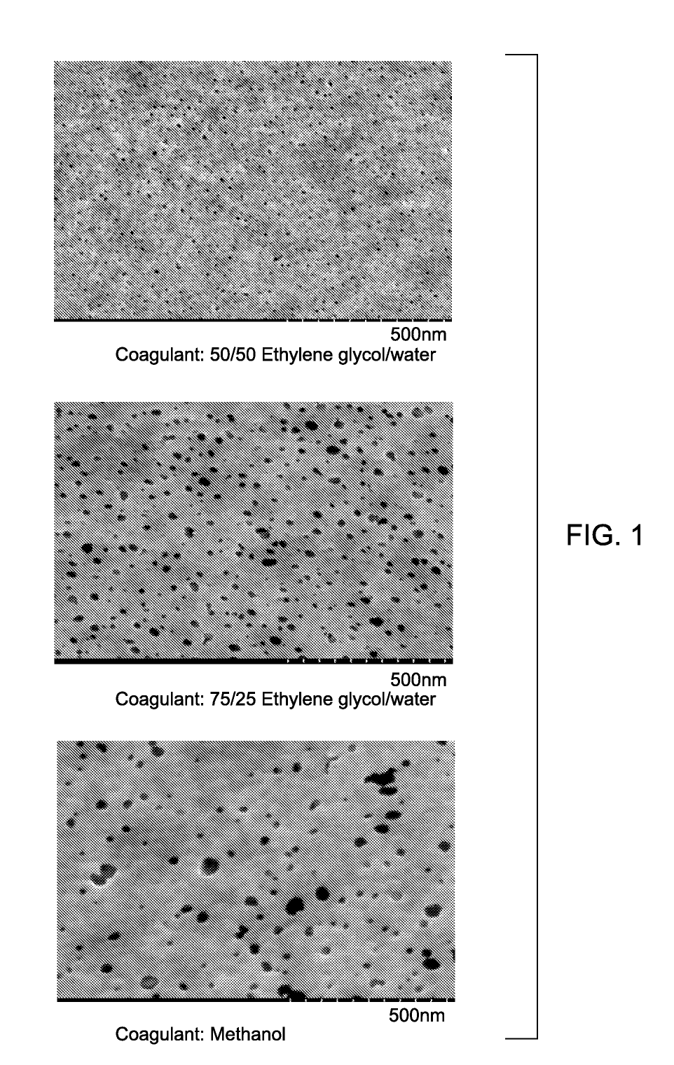

A block copolymer produced by the identical route described in Example 3 (Mw=87K, Mw=37K, 2.33) was dissolved in N-methylpyrollidone to produce a 20 weight % solution. The solution was cast onto a glass plate using a 10 mil casting knife. The coated glass plates were then submerged into different coagulant solutions to produce microporous membranes. Scanning electron micrographs of the membranes indicated that they possessed pore sizes ranging from less than 5 nm to greater than 100 nm depending on the composition of the coagulant solution, as illustrated in FIG. 1.

### Example 5

### Protein Adhesion Studies

Block copolymers produced by the similar routes described in Examples 1-3 were synthesized and hollow fiber porous membranes prepared and evaluated versus commercial controls for protein adhesion. The molecular weight of the poly(ethylene glycol)monomethyl ether terminal group was about 2000 grams/mole and 5000 grams/mole. The weight percent of the poly(ethylene glycol)monomethyl ether terminal group in the copolymer was in a range from about 2 weight percent to about 20 weight percent.

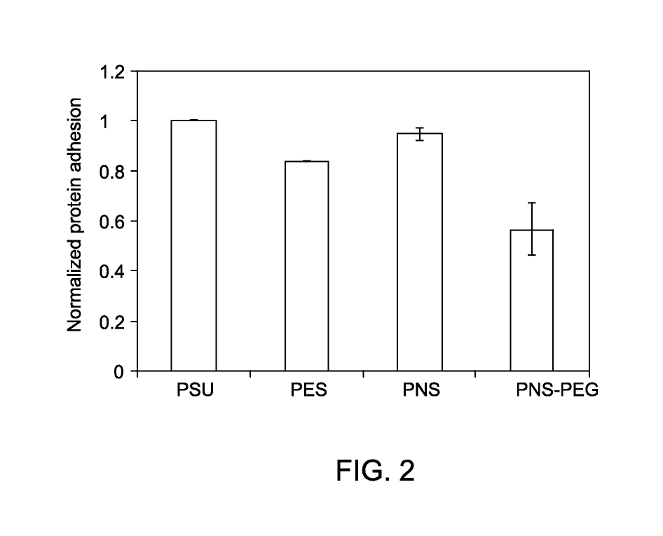

FIG. 2 shows the normalized protein adhesion performance (normalized with respect to PSU) for commercial controls: polysulfone (PSU) and polyether sulfone (PES) versus polynitrilesulfone (PNS) and polynitrile sulfone with poly(ethylene glycol)monomethyl ether terminal group (PNS-PEG, 10 weight percent of PEG having a Mₙ of about 5000 grams/mole).

As illustrated in FIG. 2, copolymer with the terminal group provides improved performance versus commercial controls (PSU and PES) as well as copolymer without the terminal group (PNS). The improved protein adhesion performance may be attributed to the presence of the hydrophilic terminal group in the copolymer. Further, it was shown that the hydrophilic terminal group in the copolymer does not inhibit the ability of the copolymer to make hydrophilic hollow fiber membranes with useful porosities and mechanical performance for commercial hollow fiber applications.

The appended claims are intended to claim the invention as broadly as it has been conceived and the examples herein presented are illustrative of selected embodiments from a manifold of all possible embodiments. Accordingly, it is the Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied; those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

1. A membrane, comprising:
a polyarylnitrile copolymer comprising structural units having a formula (I) and at least one terminal group having a formula (II) 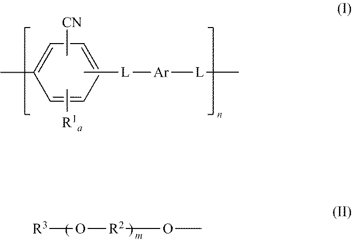
wherein “a” is 0, 1, 2, or 3;
“m” is an integer having a value of 35 to 150;
R¹ is independently at each occurrence a hyrogen atom, a halogen atom, a nitro group, a cyano group, a C₁-C₁₂ aliphatic radical, a C₃-C₁₂ cycloaliphatic radical, or a C₃-C₁₂ aromatic radical;
R² and R³ are independently a C₁-C₁₂ aliphatic radical, a C₃-C₁₂ cycloaliphatic radical, or a C₃-C₁₂ aromatic radical;
L is an oxygen atom or a sulfur atom; and
Ar is independently at each occurrence a residue of an aromatic diol or a residue of an aromatic dihalide.

2. The membrane of claim 1, wherein Ar comprises structural units having a formula (III), (IV), or combinations thereof 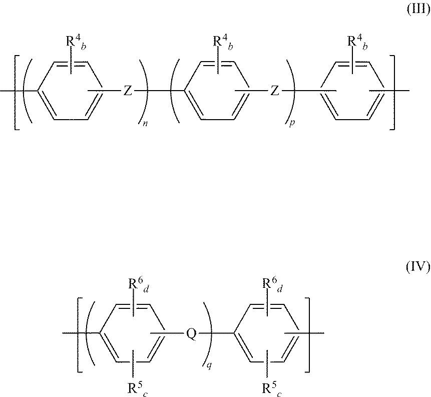
wherein “b”, “c’ and ‘d” are independently 0, 1, 2, 3, or 4;
“n”, “p” and “q” are independently 0 or 1;
Z is a bond, an oxygen atom, a sulfur atom, a sulfinyl group, a sulfonyl group, a phenylphosphine group, a C₁-C₁₂ aliphatic radical, a C₃-C₁₂ cycloaliphatic radical, or a C₃-C₁₂ aromatic radical;
Q is a bond, an oxygen atom, a sulfur atom, a C₁-C₁₂ aliphatic radical, a C₃-C₁₂ cycloaliphatic radical, or a C₃-C₁₂ aromatic radical; and
R⁴, R⁵, and R⁶ are independently at each occurrence a hyrogen atom, a halogen atom, a nitro group, a C₁-C₁₂ aliphatic radical, a C₃-C₁₂ cycloaliphatic radical, or a C₃-C₁₂ aromatic radical.

3. The membrane of claim 1, wherein the polyarylnitrile comprises structural units having a formula (V):

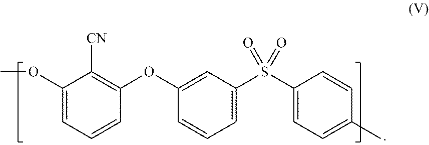

4. The membrane of claim 1, wherein the terminal group comprises polyethylene glycol monomethyl ether.

5. The membrane of claim 1, wherein an amount of the terminal group in the polyarylnitrile copolymer is in a range from about 2 weight percent to about 25 percent.

6. The membrane of claim 1, wherein a molecular weight of the terminal group in the polyarylnitrile copolymer is in a range from about 2000 grams/mole to about 10000 grams/mole.

7. The membrane of claim 1 having a pore size in a range from about 0.5 nanometers to about 100 nanometers.

8. The membrane of claim 1, wherein the polyarylnitrile copolymer has a contact angle with water less than about 50 degrees measured on a surface of the polyarylnitrile copolymer cast as a film on a glass substrate.

9. The membrane of claim 1, wherein the membrane has a hollow-fiber configuration.

10. A hollow-fiber module comprising a plurality of membranes as defined in claim 9.

11. A membrane for hemodialysis or hemofiltration, comprising:
a polyarylnitrile copolymer comprising structural units having a formula (I) and at least one terminal group having a formula (II) 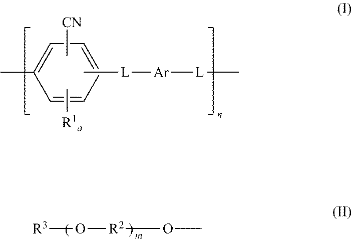
wherein “a” is 0, 1, 2, or 3;
“m” is an integer having a value of 35 to 150;
R¹ is independently at each occurrence a hyrogen atom, a halogen atom, a nitro group, a cyano group, a C₁-C₁₂ aliphatic radical, a C₃-C₁₂ cycloaliphatic radical, or a C₃-C₁₂ aromatic radical;
R² and R³ are independently a C₁-C₁₂ aliphatic radical, a C₃-C₁₂ cycloaliphatic radical, or a C₃-C₁₂ aromatic radical;
L is an oxygen atom or a sulfur atom; and
Ar is independently at each occurrence a residue of an aromatic diol or a residue of an aromatic dihalide.

12. The membrane of claim 11, wherein Ar comprises structural units having a formula (III), (IV), or combinations thereof 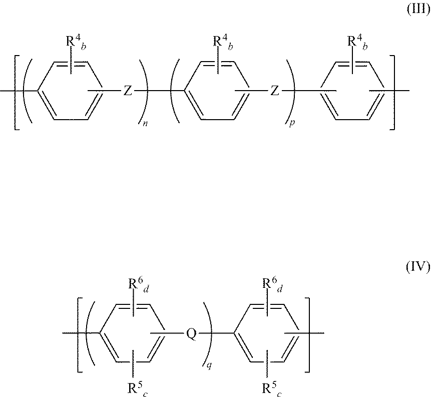
wherein “b” is 0, 1, 2, or 3;
“c’ and ‘d” are independently 0, 1, 2, 3, or 4;
“n”, “p” and “q” are independently 0 or 1;
Z is a bond, an oxygen atom, a sulfur atom, a sulfinyl group, a sulfonyl group, a phenylphosphine group, a C₁-C₁₂ aliphatic radical, a C₃-C₁₂ cycloaliphatic radical, or a C₃-C₁₂ aromatic radical;
Q is a bond, an oxygen atom, a sulfur atom, a C₁-C₁₂ aliphatic radical, a C₃-C₁₂ cycloaliphatic radical, or a C₃-C₁₂ aromatic radical; and
R⁴, R⁵, and R⁶ are independently at each occurrence a hyrogen atom, a halogen atom, a nitro group, a C₁-C₁₂ aliphatic radical, a C₃-C₁₂ cycloaliphatic radical, or a C₃-C₁₂ aromatic radical.

13. The membrane of claim 11, wherein the polyarylnitrile comprises structural units having a formula (V):

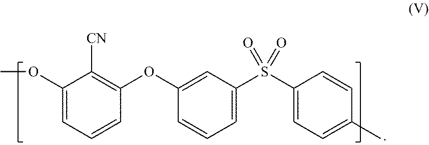

14. The membrane of claim 11, wherein the terminal group comprises polyethylene glycol monomethyl ether.

15. The membrane of claim 11, wherein an amount of the terminal group in the polyarylnitrile copolymer is in a range from about 2 weight percent to about 20 percent.

16. The membrane of claim 11, wherein a molecular weight of the terminal group in the polyarylnitrile copolymer is in a range from about 2000 grams/mole to about 10000 grams/mole.

17. The membrane of claim 11 having a pore size in a range from about 0.5 nanometers to about 100 nanometers.

18. The membrane of claim 11, wherein the polyarylnitrile copolymer has a contact angle with water less than about 50 degrees measured on a surface of the polyarylnitrile cast as a film on a glass substrate.

19. The membrane of claim 11, wherein the membrane has a hollow-fiber configuration.

20. A polyarylnitrile copolymer comprising structural units having a formula (I) and at least one terminal group having a formula (II) 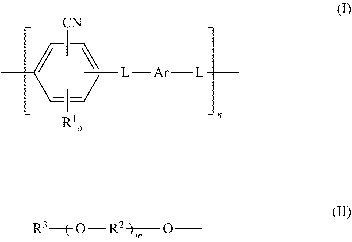
wherein “a” is 0, 1, 2, or 3;
“m” is an integer having a value of 35 to 150;
R¹ is independently at each occurrence a hyrogen atom, a halogen atom, a nitro group, a cyano group, a C₁-C₁₂ aliphatic radical, a C₃-C₁₂ cycloaliphatic radical, or a C₃-C₁₂ aromatic radical;
R² and R³ are independently a C₁-C₁₂ aliphatic radical, a C₃-C₁₂ cycloaliphatic radical, or a C₃-C₁₂ aromatic radical;
L is an oxygen atom or a sulfur atom; and
Ar comprises structural units having a formula (III), (IV), or combinations thereof 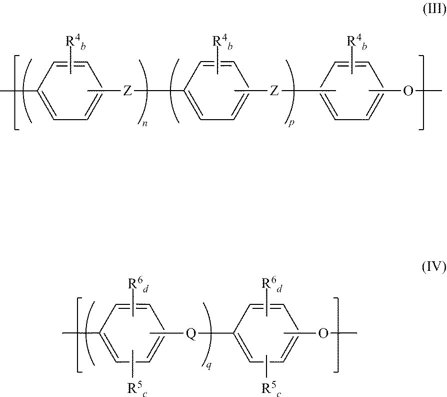
wherein “b” is 0, 1, 2, or 3;
“c’ and ‘d” are independently 0, 1, 2, 3, or 4;
“n”, “p” and “q” are independently 0 or 1;
Z is a bond, an oxygen atom, a sulfur atom, a sulfinyl group, a sulfonyl group, a phenylphosphine group, a C₁-C₁₂ aliphatic radical, a C₃-C₁₂ cycloaliphatic radical, or a C₃-C₁₂ aromatic radical;
Q is a bond, an oxygen atom, a sulfur atom, a C₁-C₁₂ aliphatic radical, a C₃-C₁₂ cycloaliphatic radical, or a C₃-C₁₂ aromatic radical; and
R⁴, R⁵, and R⁶ are independently at each occurrence a hyrogen atom, a halogen atom, a nitro group, a C₁-C₁₂ aliphatic radical, a C₃-C₁₂ cycloaliphatic radical, or a C₃-C₁₂ aromatic radical.
